(19) United States
(12) Patent Application Publication
(10) Pub. No.: US 2006/0182942 A1
(43) Pub. Date: Aug. 17, 2006

(54) Conductive organic-inorganic hybrid material comprising a mesoporous phase, membrane, electrode and fuel cell

(76) Inventors: Karine Valle, Tours (FR); Philippe Belleville, Gille (FR); Clement Sanchez, Bures Yvette (FR)

Correspondence Address: HUTCHISON LAW GROUP PLLC, PO BOX 31686, RALEIGH, NC, 27612, US

(21) Appl. No.: 10/542,813

(22) PCT Filed: Jan. 22, 2004
(86) PCT No.: PCT/FR04/50026

§ 371 Date: Jul. 20, 2005

(51) Int. Cl. B32B 3/26; B32B 3/06; B32B 5/14; B05D 1/08; C23C 4/00; H05H 1/26

(52) U.S. Cl. 428/304.4; 428/307.3; 428/308.4; 427/446

(57) ABSTRACT

A conductive organic-inorganic hybrid material comprising a mineral phase in which walls define pores forming a structured mesoporous network with open porosity; said material further comprising an organic oligomer or polymer integrated in said walls and bonded covalently to the mineral phase, and optionally another phase inside the pores, composed of at least one surfactant; at least one of the mineral phase, the oligomer, and the organic polymer having conductive and/or hydrophilic functions. Membrane and electrode comprising this material. Fuel cell comprising at least one such membrane and/or at least one such electrode. Process for preparing said material.

The present invention concerns a conductive organic-inorganic hybrid material comprising a mesoporous mineral phase.

The invention additionally concerns a membrane and an electrode comprising said material.

The invention likewise pertains to a fuel cell comprising at least one such membrane and/or at least one such electrode.

The invention relates, finally, to a process for preparing the organic-inorganic hybrid material.

The technical field of the invention may be defined, generally speaking, as being that of porous materials and more particularly of materials referred to as mesoporous.

More specifically the invention is situated within the field of mesoporous materials intended for use in electrochemistry, in particular in fuel cells, such as those of (PEMFC) (polymeric electrolyte membrane fuel cell) type.

It is known that one of the essential elements of fuel cells—for example, those used in the automotive sector and in the mobile telephony sector—is the proton exchange membrane.

These membranes structure the core of the fuel cell and are consequently required to exhibit good proton conduction performance and a low permeability to the reactant gases (H₂/O₂). The properties of the materials which constitute the solid polymer electrolytes forming these membranes, and which are required to withstand thousands of hours of operation of the cell, are essentially chemical stability and resistance to hydrolysis and to oxidation, especially hydrothermal resistance, and a certain mechanical flexibility.

Membranes prepared from perfluorinated ionomers, particularly Nafion®, meet these requirements for operating temperatures below 90° C.

This temperature, however, is insufficient to allow the integration of fuel cells comprising such membranes in a vehicle. This is because such integration presupposes an increase in the operating temperature to 100-150° C. with the aim of increasing the current/energy conversion yield and hence the efficacy of the fuel cell, but also of improving the control of heat management by reducing the volume of the radiator.

Furthermore, the conductive efficiency of proton membranes is strongly linked to the presence of water in the medium. At temperatures greater than 100° C., water is rapidly evacuated from the membrane, the conductivity falls, and the fuel permeability goes up. At these temperatures, this decrease in performance may be accompanied by degradation of the membrane. In order to solve the problems of membrane dryout in fuel cells at high temperature, namely at least 100° C., the maintenance of a maximum, 80-100% relative humidity is necessary, but is difficult to realize by means of an external source.

On the other hand, it is known that the insertion or growth of a hygroscopic filler “in situ” promotes the retention of water within the polymer, retards this process of dehydration of the proton medium, and thus ensures the conduction of protons. Besides it hydrophilic nature, this functional filler may intrinsically possess conductive properties and may thus increase the performance of the membrane.

In order to increase the retention of water in the membranes in fuel cells at high temperature, numerous composite membranes have been developed, in particular by growth of hydrophilic inorganic nanoparticles. These mineral nanofillers can be synthesized by a sol-gel route in perfluorinated sulfonated organic matrices, but also in matrices composed of polyaromatic compounds, or of polyethers. These membranes are presently called organic-inorganic hybrid membranes.

The mineral particles may be:

conductive, in which case they are of acidic type, such as, for example, tungstophosphoric or tungstosilicic or antimonic acid, or of metal phosphate or phosphonate type, such as zirconium phosphate [1-7];

nonconductive and simply hydrophilic, such as metal and metalloid oxides TiO₂, SiO₂ etc. [8-19].

Besides improving the water management at high temperature, the reduction of the permeability of the membrane with respect to fuels is demonstrated in these organic-inorganic hybrid membranes relative, for example, to conventional membranes of Nafion® type. The thermal and chemical stability, however, remain limited since they are inherent in the sulfonated organic polymer matrix employed.

Studies presented recently by Rozière et al. [19] pertain to the functionalization of the silicate network by an amine group, which improves the interaction between the inorganic phase and the organic polymer via ionocovalent bonds.

Research conducted by Honma et al. [20-21] and Park et al. [22] on the growth of continuous organic-inorganic hybrid matrices by dispersion of heteropolyacids respectively in poly(isocyanopropyl)silsesquioxane-organic polymer (PEG, PPO, PTMO) copolymers or in cocondensates of glycidyloxy-propyltrimethoxysilane (GLYMO) and tetraethoxysilane is opening up new perspectives on the use of thermally stable polymeric chains.

Although mineral heteropolyacids remain highly attractive on account of their intrinsic conductivity, their incorporation at high filler levels (30% to 70% by mass) into polymers with low or no conductivity gives rise generally to problems of consequent and progressive leaching during the operation of the cell, owing to their solubility in water.

In parallel with the composite or organic-inorganic hybrid materials described above, mesoporous materials, which were initially envisioned for catalysis, in other words, essentially silica and aluminosilicates, have begun to attract the attention of certain electrochemists.

It will be recalled that materials referred to as mesoporous are solids which within their structure have pores possessing a size of typically between 2 and 80 nm, which is intermediate between that of micropores and that of macropores.

Typically, mesoporous materials are amorphous or crystalline metal oxides in which the pores are generally distributed randomly with a very broad distribution in the size of the pores.

Structured mesoporous materials, called “mesostructured” materials, correspond, for their part, to structured pore networks which exhibit an organized spatial layout of mesopores. This spatial periodicity of the pores is characterized by the appearance of at least one low-angle peak in an X-ray scattering diagram; this peak is associated with a repeat distance which is generally between 2 and 50 nm. The nanostructure is verified by transmission electron microscopy.

In this context, the sol-gel process offers innovative strategies in the construction of these organized mesoporous edifices, particularly by inorganic polymerization within organized molecular systems (OMS) of surfactants or within organized polymeric systems (OPS) of block copolymers. In the presence of OMS-type templating agents, this gentle chemistry also makes it possible, starting from inorganic and organometallic precursors, to synthesize organic-mineral-type mesostructured networks of a kind referred to as organic-inorganic hybrid materials. The properties of these mesoporous organic-inorganic hybrid materials depend not only on the chemical nature of the organic and inorganic components but also on the synergy which may appear between these two chemistries.

This is why these materials are often called “multifunctional” materials.

The degree of organization is governed by the nature of these two organic and inorganic entities but also by the multiscale layout of this arrangement. Thus, the integration into an ordered mesoporous structure, into both the “walls” and the pores, of chemical functionalities capable of inducing specific properties is of great interest in a variety of applications (catalysis, filtration, electrochemistry, etc.) [37].

Colomer et al. [23-24] have prepared nonorganized mesoporous silicas by coaggregating silica nanoparticles of different sizes or by (pH-)controlled growth of colloidal silica. They have studied the impact of such porosities on the proton conductivity of these silicas in acidic medium for PEMFCs. The high heat treatment at around 500-700° C. which is necessary to generate the porosity and the consolidation of the mesoporous silica nevertheless limits this technique to purely inorganic networks.

In contrast, the structuring of mesoporous silica synthesized by using surface-active agents does not require a high heat treatment and hence permits organic functionalization during the growth of the network [25]. Moreover, the structure of these materials is often well defined. This organization, in association with the high specific surface area, plays an important part in improving the conduction of protons through the hydrophilic network. Minami et al. [26-28] have impregnated this type of silica with sulfuric or phosphoric acid, studying the influence of the pore size and of the specific surface area on conductivity and porosity. The properties obtained in terms of conductivity are of very great interest, being of the order of 2-3-10⁻¹ S/cm.

Moreover, different mesostructured organic-inorganic hybrid silicas, possessing an SO₃H [29-31] or PO₃H₂ [32] functionality in the pores, offer an interesting potential for fuel cells, despite having been essentially developed for catalytic applications. Kaliaguine et al. [33], who work in the electrochemical field, have carried out conductivity and water-adsorption measurements in this type of compound. These silicas exhibit in the round a pronounced hydrophilic character, and the conductivity measurements are of interest for non-optimized systems, being of the order of 10⁻² S/cm at 80° C. and 100% relative humidity.

The recent literature references above concerning the possible use of mesoporous materials in electrochemical devices, such as the mesostructured mesoporous silicas constructed by OMS and OPS, are unable to give rise to a direct application for fuel cells, because it is impossible to convert the materials as described and mentioned in those documents into the form of membranes.

A number of articles relate to the integration of a polymeric organic chain bonded covalently to the oxide and integrated in the walls of the mesoporous network. In particular, Wei et al. [34] have synthesized a mesoporous organic-inorganic hybrid material of polystyrene-SiO₂ type from a silylated polymer and TEOS in the presence of a surface-active agent, dibenzoyltartaric acid. Other authors, such as Loy et al. [35] or Stein et al. [36], have described the construction of a mesostructured silicate network whose walls contain integrated ethylene chains of 1 to 4 units. Again, these materials cannot be formed as membranes and are not possessed of any conductivity.

There exists, therefore, a need for a mesoporous material which can be converted into the form of a membrane, in particular a homogeneous and flexible membrane.

There also exists a need for a mesoporous material which is thermally and chemically stable and resistant to hydrolysis and to oxidation.

There subsequently exists a need for a mesoporous material of this kind which in addition can be provided with a high conductivity, in particular a high ion—preferably proton—conductivity, and which can thus be employed in membrane form in electrochemical devices, such as fuel cells, having high operating temperatures, in the region, for example, of 100 to 150° C.

This material, in the context of such a use, must allow—unlike the membranes of the prior art, based for example on perfluorinated ionomers—a high level of water retention, even at high temperature, in order to avoid membrane dryout, and must possess a high conductivity and a low fuel permeability at high temperature, in association with an absence of degradation of the membrane.

The aim of the present invention is to provide a mesoporous organic-inorganic hybrid material which meets all of the needs indicated above.

The aim of the present invention is, further, to provide a mesoporous material which does not exhibit the disadvantages, defects and drawbacks of the prior-art materials and which, if equipped with conductive functions, can be used in an electrochemical device, such as a fuel cell, while exhibiting excellent performance.

This aim and other, further aims are attained in accordance with the invention by a conductive organic-inorganic hybrid material comprising a mineral phase in which walls define pores forming a structured mesoporous network with open porosity; said material further comprising an organic oligomer or polymer integrated in said walls and bonded covalently to the mineral phase, and optionally another phase inside the pores, composed of at least one surface active agent; at least one of the mineral phase, and the organic oligomer or polymer having conductive and/or hydrophilic functions.

The specific structure of the conductive hybrid material according to the invention, which comprises at least one mesoporous mineral phase (with, optionally, a surface active phase), whose mechanical strength is ensured by an organic polymeric chain integrated in the walls of the mesoporous network, has never been described in the prior art.

This is because the prior art has never documented the formation of a mesoporous organic-inorganic hybrid material—in the form, for example, of a membrane—which is continuous and contains integrated polymer, said material further having conductive and/or hydrophilic functions, in the pores, for example.

In particular, by virtue of their high specific surface area and their particular structure, the use of such conductive organic-inorganic hybrid materials comprising a mesoporous phase in proton conductive membranes offers numerous possibilities promoting the continuity of conduction pathways subject to the presence of an open porosity.

By open porosity is meant a porosity formed from pores which open out and remain accessible to the conductive species.

According to the invention, at least one of the mineral phase and the organic oligomer or polymer has conductive and/or hydrophilic functions.

The mineral phase may thus have conductive and/or hydrophilic functions on the surfaces of its pores.

Similarly, the organic oligomer or polymer may have conductive and/or hydrophilic functions.

In one embodiment the other, optional phase inside the pores, composed of at least one surface active agent, may also, optionally, have conductive and/or hydrophilic functions; it being understood that the mineral phase and/or the organic oligomer or polymer compulsory has conductive and/or hydrophilic functions.

By conductive functions it is meant, generally, that these functions exhibit an ion conductivity, preferably a proton conductivity.

Where the material solely comprises a mineral phase and an organic oligomer or polymer, one or the other of them, or both, may have conductive and/or hydrophilic functions.

Where the material further comprises a surface active agent, at least one of the mineral phase and the organic oligomer or polymer has conductive and/or hydrophilic functions, or else any two of the mineral phase, the organic oligomer or polymer, and the surface active agent have conductive and/or hydrophilic functions, or else the surface active agent and the mineral phase and the organic oligomer or polymer all three have conductive and/or hydrophilic functions.

Generally speaking, the material according to the invention has an open porosity serving as a continuous network of proton conduction. The mesoporous skeleton is preferably hygroscopic and possesses a conductive functionality in its pores (the compound in question is, for example, a functionalized metal oxide) which thus ensures proton transport and hydration. The organic polymer or oligomer reinforces the walls of the mineral phase and provides it with structure, thereby allowing the conductive material, in contrast to the prior art, to be brought into the form of a membrane.

A true synergy is produced between the mineral phase and the organic oligomer or polymer, which endows the material according to the invention with a unique combination of physical, electrical, and mechanical properties, never attained in the prior art.

The conductive functions may be selected from cation exchange groups and/or anion exchange groups.

The cation exchange groups may be selected, for example, from the following groups: —SO₃M; —PO₃M₂; —COOM and —B(OM)₂, where M represents hydrogen, a monovalent metal cation, or ⁺NR¹₄, where each R¹, independently, represents a hydrogen, an alkyl radical or an aryl radical.

The anion exchange groups may be selected for example from the following groups: pyridyl; imidazolyl; pyrazolyl; triazolyl; the radicals of formula ⁺NR²₃X⁻, where X represents an anion such as, for example, F, Cl, Br, I, NO₃, SO₄H, or OR (where R represents an alkyl radical or an aryl radical), and where each R², independently, represents a hydrogen, an alkyl radical or an aryl radical; and the basic aromatic or nonaromatic radicals containing at least one radical selected from imidazole, vinylimidazole, pyrazole, oxazole, carbazole, indole, isoindole, dihydrooxazole, isoxazole, thiazole, benzothiazole, isothiazole, benzimidazole, indazole, 4,5-dihydropyrazole, 1,2,3-oxadiazole, furazan, 1,2,3-thiadiazole, 1,2,4-thiadiazole, 1,2,3-benzotriazole, 1,2,4-triazole, tetrazole, pyrrole, aniline, pyrrolidine, and pyrazole radicals.

The mineral phase is generally composed of at least one oxide selected from metal oxides, metalloid oxides and mixed oxides thereof.

Said oxide is generally selected from the oxides of silicon, titanium, zirconium, hafnium, aluminum, tantalum, tin, rare earths or lanthanides such as europium, cerium, lanthanum or gadolinium, and mixed oxides thereof.

The mineral phase of the material according to the invention is a mesostructured phase, which means, more specifically, that the mesoporous network exhibits an organized structure with a repeating unit.

For example, the mesoporous network may exhibit a cubic, hexagonal, lamellar, vermicular, vesicular or bicontinuous structure.

The size of the pores of the mesoporous network is generally from 1 to 100 nm, preferably from 1 to 50 nm.

The oligomer or the organic polymer integrated in the walls of the mineral phase must generally meet a certain number of conditions.

Above all, said oligomer or said polymer must generally be thermally stable; by thermally stable is meant that it retains its properties under the action of heat.

The polymer or the oligomer must generally, furthermore, not be sensitive to hydrolysis and to oxidation at, in particular, high temperatures, especially at the operating temperatures of fuel cells, and must retain this insensitivity for several thousand hours.

Moreover, generally, the polymer or the oligomer selected must be:

soluble in an alcoholic or aqueous-alcoholic medium or in other solvents that are miscible or partly miscible in water, because the organization of the optional surfactant in a liquid medium, the templating agent of the mesoporous phase, occurs in highly polar media such as water;

plastic, so as to provide sufficient strength to the mesoporous inorganic phase and form a self-supporting film: that is to say that the polymer may be termed a (mechanically) structuring polymer.

The oligomer or the organic polymer will be generally selected from polyetherketones (PEK, PEEK, PEEKK); polysulfones (PSU), Udel® for example; poly-ethersulfones, Vitrex® for example; polyphenyl-ethersulfones (PPSU), Radel® for example; styrene/ethylene (SES), styrene/butadiene (SBS) and styrene/isoprene (SIS) copolymers, Kraton® for example; polyphenylenes, such as poly(phenylene sulfide)s and poly(phenylene oxide)s; polyimidazoles, such as polybenzimidazoles (PBI); polyimides (PI); polyamideimides (PAI); polyanilines; polypyrroles; polysulfonamides; polypyrazoles, such as polybenzopyrazoles; polyoxazoles, such as polybenzoxazoles; polyethers, such as poly(tetramethylene oxide)s and poly(hexamethylene oxide)s; poly((meth)acrylic acid)s; polyacrylamides; polyvinyls, such as poly(vinyl ester)s, for example, polyvinyl acetates, polyvinyl formates, polyvinyl propionates, polyvinyl laurates, polyvinyl palmitates, polyvinyl stearates, polyvinyl trimethylacetates, polyvinyl chloroacetates, polyvinyl trichloroacetates, polyvinyl trifluoroacetates, polyvinyl benzoates, polyvinyl pivalates, and polyvinyl alcohols; acetal resins, such as polyvinyl butyrals; polyvinylpyridines; polyvinylpyrrolidones; polyolefins, such as polyethylenes, polypropylenes, and polyisobutylenes; poly(styrene oxide)s; fluoro resins and polyperfluorocarbons, such as polytetrafluoroethylenes (PTFE), for example, Teflon®; poly(vinylidene fluoride)s (PVDF); polychlorotrifluoroethylenes (PCTFE); polyhexafluoropropenes (HFP); perfluoroalkoxides (PFA); polyphosphazenes; silicone elastomers; and block copolymers comprising at least one block composed of a polymer selected from the above polymers.

When the material comprises a third phase, inside the pores, composed of a surface active agent, the latter may be selected from: surfactants, such as alkyltrimethylammonium salts, alkyl phosphate salts and alkylsulfonate salts; acids such as dibenzoyltartaric acid, maleic acid or long-chain fatty acids; bases such as urea or long-chain amines; phospholipids; doubly hydrophilic copolymers whose amphiphilicity is generated in situ by interaction with a substrate; and amphiphilic multiblock copolymers comprising at least one hydrophobic block in combination with at least one hydrophilic block. Among these polymers mention may be made, for example, of Pluronics® based on PEO (poly(ethylene oxide)) and PPO (poly(propylene oxide)), of (EO)ₙ—(PO)ₘ—(EO)ₙ type, copolymers of ((EO)ₙ—(PO)ₘ)ₓ—NCH₂CH₂N—((EO)ₙ—(PO)ₘ)ₓ type (Tetronic®), the class Cₙ(EO)ₘ(OH) (Cₙ=aryl and/or alkyl chain, EO=ethylene oxide chain), for example, Brij, Triton or Igepal®, and the class (EO)ₘ-sorbitan-Cₙ (Tween®).

It is important to note that the organic polymer or oligomer must in no case be confused with an optional surface active polymer. Although both called “polymers”, these compounds are different in terms both of their structure and of their effects. The organic oligomer or polymer integrated in the walls is a polymer termed (mechanically) “structuring”, whereas the optional surface active polymer is termed “templating” “texturizing”.

The invention concerns, moreover, a membrane comprising the material as described above, optionally deposited on a support.

By membrane is meant that the material is in the form of a film or sheet with a thickness, for example, of 50 nm to several millimeters, preferably from 10 to 500 μm.

The invention also pertains to an electrode comprising the material, as described above.

The excellent properties of the material according to the invention, in the form of a membrane and/or an electrode, make it particularly suitable for use in an electrochemical device, a fuel cell for example.

The invention therefore likewise concerns a fuel cell comprising at least one membrane and/or electrode as described above.

The invention likewise pertains to a process for preparing the material such as described above, in which the following steps are realized:

a)—a precursor compound A is synthesized, composed of an organic oligomer or polymer which carries precursor functions of the mesoporous mineral phase, and an organic-inorganic hybrid solution is prepared in a solvent of said precursor compound A;

b)—the organic-inorganic hybrid solution obtained in step a) is hydrolyzed and allowed to age;
c)—the hydrolyzed and aged organic-inorganic hybrid solution of the precursor compound A, obtained in step b), is diluted in a solution, in a solvent, of a mineral precursor B intended to constitute the mesoporous mineral phase, whereby a new organic-inorganic hybrid solution is obtained;

d)—the organic-inorganic hybrid solution obtained in step c) is hydrolyzed and allowed to age;
e)—a solution is prepared, in a solvent, of a surface active agent D, a templating, texturizing, agent for the mesoporous mineral phase;

f)—the solution obtained in step c) is mixed with the solution obtained in step e) to give a solution S;

g)—optionally, the solution S obtained in step f) is hydrolyzed and allowed to age;

h)—the hydrolyzed and aged hybrid solution S is deposited or impregnated on a support;

i)—solvents are evaporated under controlled pressure, temperature, and humidity conditions;

j)—a heat treatment is carried out to consolidate the material;

k)—the surface active agent D is optionally removed completely or partially;

l)—the support is separated or removed, optionally.

It should be noted that, when the material prepared is in the form, in particular, of a thin film, or layer, and when it is deposited or impregnated on a substrate, a planar substrate, for example, the process may be defined as being a process for preparing a membrane.

The process according to the invention exhibits a unique sequence of specific steps which allow appropriate growth by the “sol-gel” route of the optionally functionalized mesoporous inorganic (mineral) phase in the pores and containing, integrated in its walls, an organic polymer or oligomer. The conditions of the process ensure that a material is obtained, and then that a homogeneous and flexible membrane is obtained, coupled with the construction of the mesoporosity.

By virtue of the process according to the invention, the growth of the mesoporous phase optionally functionalized in its pores and containing, integrated in its walls, an organic polymer or oligomer is perfectly controlled, especially in the presence of a templating, texturizing, surface active agent.

Advantageously, a chelating agent E is further added to the solution S obtained in step f).

Advantageously, during step c), a compound C, carrying, on the one hand, conductive and/or hydrophilic functions and/or functions which are precursors of conductive and/or hydrophilic functions, and, on the other hand, functions capable of undergoing bonding to the surfaces of the pores of the mesoporous network, is further added to the solution of mineral precursor A. Advantageously, the process further comprises a final step of treatment to liberate or generate conductive and/or hydrophilic functions on the surface of the pores of the material.

Advantageously, the organic-inorganic hybrid solution obtained in step a) (step b)) is left to age at a temperature of 0° C. to 300° C., preferably of 20° C. to 200° C.; at a pressure of 100 Pa to 5·10⁶ Pa; preferably of 1000 Pa to 2·10⁵ Pa; for a time of a few minutes to a few days, preferably of one hour to one week.

Advantageously, the solution obtained in step c) d) (step d) is left to age at a temperature of 0° C. to 300° C., preferably of 20° C. to 200° C.; at a pressure of 100 Pa to 5·10⁶ Pa; preferably of 1000 Pa to 2·10⁵ Pa; for a time of a few minutes to a few days, preferably of one hour to one week.

Advantageously, the solution S obtained in step f) is left to age at a temperature of 0° C. to 300° C., preferably of 20° C. to 200° C.; at a pressure of 100 Pa to 5·10⁶ Pa; preferably of 1000 Pa to 2·10⁵ Pa; for a time of a few minutes to a few days, preferably of one hour to one week.

Advantageously, the solvents are evaporated at a temperature of 0° C. to 300° C., preferably of 10° C. to 160° C.; at a relative humidity (RH) of 0 to 100%, preferably of 20% to 95%. These evaporation conditions make it possible in particular to obtain a homogeneous and flexible membrane which has the required mesoporosity.

In step h), the organic-inorganic hybrid solution may be deposited or impregnated on a support by means of a method selected from the method of deposition by centrifugal coating known as spin coating, the method of deposition by immersion and withdrawal known as dip coating, the method of deposition by laminar coating known as meniscus coating, the method of deposition by spraying known as “spray coating”, or the method of deposition by casting and the method of deposition by evaporation.

The invention will be better understood on reading the description which now follows, and which is given by way of illustration and not of limitation, referring to the attached drawing, in which:

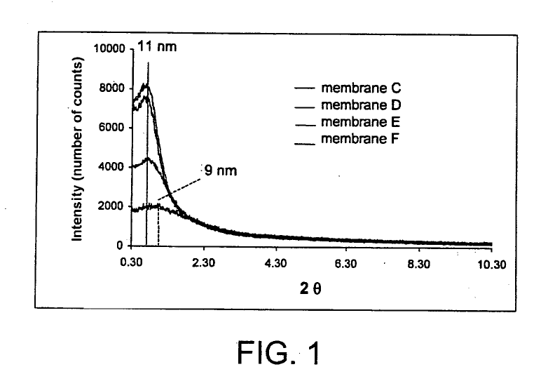

FIG. 1 is a graph which gives small-angle X-ray scattering diagrams for membranes C, D, E and F prepared in the example.

The intensity (in number of counts) is plotted on the ordinate, and 20 is plotted on the abscissa.

The curves represent, from top to bottom, the diagrams for membranes F, C, D and E, respectively.

The text below describes a process for preparing, according to the invention, a conductive organic-inorganic hybrid material in the form of a membrane having a mesoporous mineral phase whose walls are provided with polymeric or oligomeric organic chain links bonded to the mineral network; a conductive function is present, for example, in the pores; and a surfactant may also be present in these same pores.

This process comprises the following steps:

Step 1: The synthesis begins with the preparation of the organometallic precursor A, which will provide the mesoporous network with flexibility and mechanical strength. Typically a branched or unbranched polymeric chain is functionalized with at least two metal alkoxide functions (RO)ₙM′-polymer-M′(OR)ₙ, where M′ is a metalloid or a metal such as a p metal or a transition metal or else a lanthanide. Examples of M′ are Si, Ti, Zr, Al, Sn, Ce, Eu, La, and Gd, and R is an organic group of alkyl or aryl type.

The polymer is selected for its mechanical properties (structuring and flexibility), its heat resistance properties and its properties of resistance to the hydrolysis and to the oxidation of the medium of the fuel cell. Typically this polymer may be selected from the polymers described above. These various polymers may include cation exchange groups: —SO₃M, —PO₃M₂, —COOM or —B(OM)₂ (with M=H, monovalent metal cation, or N⁺R¹₄ (with R¹=H, alkyl or aryl); or precursors: SO₂X, COX or PO₃X₂ (X=F, Cl, Br, I or OR (R=alkyl or aryl)). In another model, the various polymers may include anion exchange groups: ₋⁺NR²₃X⁻, where X represents an anion such as, for example, F, Cl, Br, I, NO₃, SO₄H or OR, R being an alkyl radical or an aryl radical, and or each R² represents, independently, H, alkyl, aryl, pyridinium, imidazolinium, pyrazolium or sulfonium; it will also be possible to refer to the list given above.

Step 2: This precursor A is diluted in the presence of a metal alkoxide or metal salt B in a liquid medium; and the selection of the solvent or of the solvent mixture is made in dependence on the medium of miscibility of the surfactant agent used subsequently, typically alcohols, ethers or ketones which are miscible or partially miscible with water.

To this metallic precursor, a molar amount C of an organometallic compound containing hydroxyl functions or hydrolyzable functions of alkoxide type, and non-hydrolyzable or grafted functions, may be added over the same time as the mixture (A and B). This compound C corresponds, for example, to the formula R³ₓR⁴_{y}M″OR_{(n-(x+y))}, where M″ represents an element from group IV, for example: Si, or to the formula ZR³ₓZR⁴_{y}M′″OR_{(n-(x+y))}, where M′″ is a p metal, a transition metal or a lanthanide, for example: Ti, Zr, Ta, Al, Sn, Eu, Ce, La or Gd, where n is the valence of the metal, Z is a complexing function of monodentate type, such as acetate, phosphonate or phosphate, or of bidentate type, such as β-diketones and derivatives thereof, and α- or β-hydroxy acids, R³, R⁴, and R are organic substituents of H, alkyl or aryl type. Particularly for R³, these substituents may include cation exchange groups: —SO₃M, —PO₃M₂, —COOM or —B(OM)₂, in which M=H, a monovalent metal cation, or N⁺R¹₄ (where each R¹ represents, independently, H, alkyl or aryl); or precursors of cation exchange groups: SO₂X, COX or PO₃X₂, (X⊂F, Cl, Br, I or OR′ (R′=alkyl or aryl)); or anion exchange groups, such as ⁺NR²₃X⁻, where X represents an anion such as, for example, F, Cl, Br, I, NO₃, SO₄H or OR, R being an alkyl radical or an aryl radical, and each R² represents, independently, H, alkyl, aryl, pyridinium, imidazolinium, pyrazolium or sulfonium; it will also be possible to refer to the list given earlier on above.

Step 3: This solution is mixed with a surfactant agent solution which will play the part of the templating, texturizing agent. The selection of the templating agent depends on the desired mesostructure (cubic, hexagonal, lamellar, vermicular, vesicular or bicontinuous), on the size of the pores and the walls of this mesostructure; and on its solubilization with the other compounds of the present invention, namely the mineral precursors. Use will be made of surfactant-containing templating agents, such as alkyltrimethylammonium salts, alkyl phosphate salts and alkylsulfonate salts; or of acids, such as dibenzoyltartaric acid, maleic acid, or long-chain fatty acids; or of bases, such as urea and long-chain amines, to construct mesoporous edifices in which the size of the pores is limited to a few nanometers (1.6 to 10 nm) and the size of the walls to approximately 1 nm.

To prepare mesoporous phases with a larger pore size (up to 50 nm), use will be made of phospholipids; doubly hydrophilic copolymers whose amphiphilicity is generated in situ by interaction with a substrate; or amphiphilic multiblock copolymers comprising at least one hydrophobic block in combination with at least one hydrophilic block. Among these polymers, mention may be made, for example, of Pluronics® based on PEO (poly(ethylene oxide)) and PPO (poly(propylene oxide)), of (EO)ₙ—(PO)ₘ—(EO)ₙ type, copolymers of ((EO)ₙ—(PO)ₘ)ₓ—NCH₂CH₂N—((EO)ₙ—(PO)ₘ)ₓ type (Tetronic®), the class Cₙ(EO)ₘ(OH) (Cₙ=aryl and/or alkyl chain, EO=ethylene oxide chain), for example, Brij®, Triton® Tergitol or Igepal®, and the class (EO)ₘ-sorbitan-Cₙ (Tween®). These various blocks were also able to be of acrylic nature, PMAc (poly(methacrylic acid)) or PAAC (poly(acrylic acid)), aromatic PS (polystyrene), vinylic PQVP (polyvinylpyridine), PVP (polyvinylpyrrolidone), PVEE (polyvinyl ether) or other PDMS (polysiloxane) kind. These various blocks may be functionalized by conductive groups of cation exchange type; or precursors of cation exchange groups; or anion exchange groups, such as, for example, PSS (poly(styrenesulfonic) acid) or precursors of anion exchange groups, already defined above. The selected structure-directing agent D is dissolved or diluted in an aqueous-alcoholic medium or in an aqueous-based solvent mixture compatible with the medium used to dilute the metallic precursors A, B and C.

Step 4: This surfactant-containing organic-inorganic hybrid solution is subsequently hydrolyzed in an acidic or basic medium for a specific time, which may extend from a few hours to several days, depending on the selection of the metal precursor, at a controlled temperature from ambient to reflux. Particularly in the case of TiO₂ or ZrO₂ precursors, a chelating agent E, such as, typically, acetylacetone or acetic acid or phosphonates, may be introduced in order to control the hydrolysis/condensation of the inorganic network.

Step 5: The membrane is produced by deposition of the organic-inorganic hybrid solution and evaporation under controlled pressure, temperature and humidity (15° C.<T<80° C.). The evaporation conditions are very important for the organization of the surfactant in the liquid medium, and the final formation of the mesoporous network. The membranes obtained are subsequently heat-treated at between 50° C. and 300° C., to effect consolidation. The surfactant present in the mesopores of the membrane may be removed by a gentle technique, such as, for example, washing in acidic, aqueous-alcoholic medium. A post-reaction to liberate or generate the conductive function bonded to the inorganic network may be carried out. Typically this type of post-reaction may be:

an oxidation of a mercaptan group (—SH) by hydrogen peroxide in sulfonic acid SO₃H, or

the hydrolysis of a dialkylphosphonate function (RO)₂(O)P— with HCl, directly or via the formation of an intermediate (Me₃SiO)₂(O)P—, followed by hydrolysis with MeOH, to form a phosphonic acid —PO₃H₂.

This post-reaction may also correspond to a grafting of the surface hydroxyls M-OH of the inorganic network of the membrane with a metal organoalkoxide. In all of these cases, the membrane is placed in a liquid medium, to allow it to swell and to allow the reactive molecular entities to spread within the pores of the membrane.

In order to avoid any side reaction within the membrane during the operation of the cell, the proton conductive membrane is purified by various oxidizing, acidic (or basic), and aqueous washes, which allow all of the labile organic, organomineral or inorganic entities to be removed.

In the process according to the invention, the growth of the mesoporous phase containing, integrated in its walls, an oligomer or an organic polymer is outstandingly controlled in the presence of a templating, texturizing surface active agent. This control is linked in particular to the appropriate choice of the solvents, such as alcohols, ethers, and ketones, which are miscible or partially miscible with water, of the precursors, and of the operating conditions, set out in detail earlier on above.

The membrane may also be prepared in the form of a self-supporting film, using liquid deposition techniques, namely centrifugal coating (spin coating), immersion/withdrawal (dip coating) or laminar coating (meniscus coating). This formed film is subsequently detached from its support by swelling in a solvent such as water.

The spraying technique known as spray coating may also be used to form aerosols from the organic-inorganic hybrid solution and so to carry out the impregnation of the electrodes, so as, in particular, to enhance the electrode-membrane compatibility on assembly to form the cell.

The invention will now be described by reference to the following example, which is given by way of illustration, and not of limitation.

### EXAMPLE

In this example a hybrid membrane based on a continuous silica-poly(propylene oxide) network is prepared.

Tetraethoxysilane (TEOS) and the 3-mercapto-propyltrimethoxysilane carrying an —SH function, a precursor of an acid group SO₃H, are diluted in an alcoholic solvent at 3% by mass. The surface-active agent (Brij® 30) is subsequently added to the mixture and the solution is hydrolyzed with 0.2 M hydrochloric acid. A solution of organosilicon-containing poly(propylene oxide) polymer at a dilution of 3% in the same solvent is added.

After homogenization and aging of the hybrid solution for 12 hours, the solution is evaporated in a Petri dish to form a 150 μm homogeneous, flexible membrane.

Three parameters are varied in this preparation:

the [SiO_{2-Ormosil}/polymer_{-SiO}_{₂}] mass ratio

the nature of the alcoholic solvent (ethanol, propanol, methanol and THF)

the type of functionalization of the silica, SiO₂—SH or SiO₂—SO₂H, by the addition or non-addition of hydrogen peroxide.

Table 1 gives the various formulations prepared:

TABLE 1

| | Rtₘₐₛₛ | Molar ratio | | Molar ratio |
|---|---|---|---|---|
| Name | SiO₂/polymer | (R—Si/TEOS) | Solvent | (H₂O₂/R—SiO₂) |
| A | 60% | 0.3 | C₂H₅OH | 0.4 |
| B | 50% | 0.3 | C₂H₅OH | 0.4 |
| C | 40% | 0.3 | C₂H₅OH | 0.4 |
| D | 30% | 0.3 | C₂H₅OH | 0.4 |
| E | 20% | 0.3 | C₂H₅OH | 0.4 |
| F | 0% | 0.0 | C₂H₅OH | 0.4 |
| G | 40% | 0.3 | i-C₃H₇OH | 0.4 |
| H | 40% | 0.3 | C₄H₆O | 0.4 |
| I | 40% | 0.3 | CH₃OH | 0.4 |
| J | 30% | 0.3 | C₂H₅OH | 0 |
| K | 30% | 0.3 | C₂H₅OH | 0.4 |
| | | | | (reflux) |
| L | 30% | 0.3 | C₂H₅OH | 1.1 |
| | | | | (reflux) |

These various formulations give transparent membranes in all cases.

1) Study of the Silica/Polymer Mass Ratio in the Membrane:

Membranes C to F form self-supporting films and are flexible. The flexibility of the membranes is ensured for a high silica content of between 30% and 40%.

TABLE 2

| | | Characteristics of |
|---|---|---|
| Name | Rtₘₐₛₛ SiO₂/polymer | the membrane |
| A | 60% | Brittle membrane |
| B | 50% | Rigid membrane |
| C | 40% | Semirigid membrane |
| D | 30% | Flexible membrane |
| E | 20% | Flexible membrane |
| F | 0% | Flexible membrane |

The small-angle X-ray scattering diagrams of these membranes are evidence of a mesoporous organization with a diffraction peak centered on 11 nm (see FIG. 1, where the curves, from top to bottom, give, respectively, the diagrams for membranes F, C, D and E).

2) Study of the nature of the solvent:

Membranes A and B form self-supporting films which are more flexible than membranes C and D. For a high silica content of 40%, a different flexibility is observed depending on the nature of the solvent, thereby indicating a different macroscopic membrane structure.

TABLE 3

| | | Characteristics of |
|---|---|---|
| Name | Solvent | the membrane |
| C | EtOH | Semirigid membrane |
| G | IPrOH | Flexible membrane |
| H | THF | Rigid membrane |
| I | MeOH | Rigid membrane |

3) Study of the Functionalization of the Silica, SiO₂—SH or SiO₂—SO₃H, by the Addition or Non-Addition of Hydrogen Peroxide:

The addition of hydrogen peroxide to oxidize the SH or SO₃H functions does not lower the flexibility of the membranes.

TABLE 3

| | Molar ratio | Characteristics of |
|---|---|---|
| Name | (H₂O₂/R—SiO₂) | the membrane |
| C | 0.4 | Flexible membrane |
| J | 0.4 | Flexible membrane |
| | (reflux) | |
| K | 1.1 | Flexible membrane |
| | (reflux) | |

Table 4 gives the ionic exchange capacity and conductivity values of these membranes.

TABLE 4

| | Molar ratio | IEC_{assayed} | IEC_{theoretical} | Conductivity |
|---|---|---|---|---|
| Name | (H₂O₂/R—SiO₂) | (meq H⁺· g⁻¹) | (meq H⁺· g⁻¹) | (S · cm⁻¹) |
| C | 0.4 | 0.39 | 1.15 | 2.26 × 10⁻⁵ |
| J | 0.4 | 0.39 | 1.15 | 5.34 × 10⁻⁵ |
| | (reflux) | | | |
| K | 1.1 | 1.05 | 1.15 | 5.68 × 10⁻⁴ |
| | (reflux) | | | |

In the case of a molar fraction of hydrogen peroxide of 0.4, little ionic exchange and a low conductivity are observed. This result demonstrates that the oxidation yield of the SH and SO₃H bonds is low. Increasing the amount of hydrogen peroxide by a factor of 3 allows the conductivity to be increased by a factor of 10.

### REFERENCES

(1) G. Alberti and M. Casciola Solid state protonic conductors, present main applications and future prospects, Solid State Ionics 2001, 145, 3-16.
(2) B. Bonnet, D. J. Jones, J. Roziere, L. Tchicaya, G. Alberti, M. Casciola, L. Massinelli, B. Bauer, A. Peraio and E. Ramunni Hybrid organic-inorganic membranes for a medium temperature fuel cell, Journal of New Materials for Electrochemical Systems 2000, 3, 87-92.
(3) P. Genova-Dimitrova, B. Baradie, D. Foscallo, C. Poinsignon and J. Y. Sanchez Ionomeric membranes for proton exchange membrane fuel cell (PEMFC): sulfonated polysulfone associated with phosphatoantimonic acid, Journal of Membrane Science 2001, 185, 59-71.
(4) N. Miyake, J. S. Wainright and R. F. Savinell Evaluation of a sol-gel derived Nafion/silica hybrid membrane for proton electrolyte membrane fuel cell applications—I. Proton conductivity and water content, Journal of the Electrochemical Society 2001, 148, A898-A904.
(5) C. Yang, S. Srinivasan, A. S. Arico, P. Creti, V. Baglio and V. Antonucci Composition Nafion/zirconium phosphate membranes for direct methanol fuel cell operation at high temperature, Electrochemical & Solid-State Letters 2001, 4, A31-A34.
(6) J. M. Fenton, H. R. Kunz and J.-C. Lin, Improved membrane electrode assemblies using ionic composite membranes for fuel cells, 2002, WO0223646.
(7) O. J. Murphy and A. J. Cisar, Composite membrane suitable for use in electrochemical devices, 2000, WO00063995.
(8) K. T. Adjemian, S. J. Lee, S. Srinivasan, J. Benziger and A. B. Bocarsly Silicon oxide Nafion composite membranes for proton-exchange membrane fuel cell operation at 80-140 degrees C., Journal of the Electrochemical Society 2002, 149, A256-A261.
(9) B. Baradie, J. P. Dodelet and D. Guay Hybrid Nafion (R)-inorganic membrane with potential applications for polymer electrolyte fuel cells, Journal of Electroanalytical Chemistry 2000, 489, 101-105.
(10) M. A. Harmer, Q. Sun, A. J. Vega, W. E. Farneth, A. Heidekum and W. F. Hoelderich Nafion resin-silica nanocomposite solid acid catalysts. Microstructure-processing-property correlations, Green Chemistry 2000, 2, 7-14.
(11) D. J. Jones and J. Roziere Recent advances in the functionalisation of polybenzimidazole and polyetherketone for fuel cell applications, Journal of Membrane Science 2001, 185, 41-58.
(12) K. A. Mauritz and J. T. Payne [Perfluorosulfonate ionomer]/silicate hybrid membranes via base-catalyzed in situ sol-gel process for tetraethylorthosilicate, Journal of Membrane Science 2000, 168, 39-51.
(13) S. P. Nunes and R. A. Zoppi Electrochemical impedance studies of hybrids of perfluorosulfonic acid ionomer and silicon oxide by sol-gel reaction from solution, Journal of Electroanalytical Chemistry 1998, 445, 39-45.
(14) E. Peled, T. Duvdevani, A. Melman and A. Aharon, Fuel Cell with proton conducting membrane, 2001, WO 0154216.
(15) P. Staiti Proton conductive membranes constituted of silicotungstic acid anchored to silica-polybenzimidazole matrices, Journal of New Materials for Electrochemical Systems 2001, 4, 181-186.
(16) H. T. Wang, B. A. Holmberg, L. M. Huang, Z. B. Wang, A. Mitra, J. M. Norbeck and Y. S. Yan Nafion-bifunctional silica composite proton conductive membranes, Journal of Materials Chemistry 2002, 12, 834-837.
(17) M. Watanabe and P. Stonehart, Polymer solid-electrolyte composition and electrochemical cell using the composition, 1996, U.S. Pat. No. 5,523,181.
(18) J. Kerres, G. Schafer and N. Nicoloso, Proton-conducting ceramic/polymer membrane for range up to 300 C, 2002, U.S. Pat. No. 2,093,008.
(19) J. Roziere, D. Jones, L. Tchicaya Boukary and B. Bauer, Materiau hybride, utilisation dudit materiau hybride et procede de sa fabrication [Hybrid material, use of said hybrid material and method for making same], 2000, WO 0205370.
(20) I. Honma, High temperature proton conductive organic-inorganic composite membranes and their manufacture, 2000, JP00090946.
(21) U. L. Stangar, N. Groselj, B. Orel, A. Schmitz and P. Colomban Proton-conducting sol-gel hybrids containing heteropoly acids, Solid State Ionics 2001, 145, 109-118.
(22) Y. Park and M. Nagai Proton exchange nanocomposite membranes based on 3-glycidoxypropyltrimethoxysilane, silicotungstic acid and alpha-zirconium phosphate hydrate, Solid State Ionics 2001, 145, 149-160.
(23) F. M. Vichi, M. T. Colomer and M. A. Anderson Nanopore ceramic membranes as novel electrolytes for proton exchange membranes, Electrochemical & Solid-State Letters 1999, 2, 313-316.
(24) M. T. Colomer and M. A. Anderson High porosity silica xerogels prepared by a particulate sol-gel route: pore structure and, proton conductivity, Journal of Non-Crystalline Solids 2001, 290, 93-104.
(25) A. Sayari and S. Hamoudi Periodic mesoporous silica-based organic—Inorganic nanocomposite materials, Chemistry of Materials 2001, 13, 3151-3168.
(26) A. Matsuda, Y. Nono, T. Kanzaki, K. Tadanaga, M. Tatsumisago and T. Minami Proton conductivity of acid-impregnated mesoporous silica gels prepared using surfactants as a template, Solid State Ionics 2001, 145, 135-140.
(27) S. Nishiwaki, K. Tadanaga, M. Tatsumisago and T. Minami Preparation and proton conductivity of surfactant-templated mesoporous silica gels impregnated with protonic acids, Journal of the American Ceramic Society 2000, 83, 3004-3008.
(28) A. Matsuda, T. Kanzaki, K. Tadanaga, T. Kogure, M. Tatsumisago and T. Minami Sol-gel derived porous silica gels impregnated with sulfuric acid—Pore structure and proton conductivities at medium temperatures, Journal of the Electrochemical Society 2002, 149, E292-E297.
(29) I. Diaz, C. Marquez-Alvarez, F. Mohino, J. Perez-Pariente and E. Sastre A novel synthesis route of well ordered, sulfur-bearing MCM-41 catalysts involving mixtures of neutral and cationic surfactants, Microporous & Mesoporous Materials 2001, 44, 295-302.
(30) D. Margolese, J. A. Melero, S. C. Christiansen, B. F. Chmelka and G. D. Stucky Direct syntheses of ordered SBA-15 mesoporous silica containing sulfonic acid groups, Chemistry of Materials 2000, 12, 2448-2459.
(31) M. H. Lim, C. F. Blanford and A. Stein Synthesis of ordered microporous silicates with organosulfur surface groups and their applications as solid acid catalysts, Chemistry of Materials 1998, 10, 467-+.
(32) R. J. P. Corriu, L. Datas, Y. Guari, A. Mehdi, C. Reye and C. Thieuleux Ordered SBA-15 mesoporous silica containing phosphonic acid groups prepared by a direct synthetic approach, Chemical Communications 2001, 763-764.
(33) S. Mikhailenko, D. Desplantier-Giscard, C. Danumah and S. Kaliaguine Solid electrolyte properties of sulfonic acid functionalized mesostructured porous silica, Microporous & Mesoporous Materials 2002, 52, 29-37.
(34) Q. W. Feng, J. G. Xu, H. Dong, S. X. Li and Y. Wei, Synthesis of polystyrene-silica hybrid mesoporous materials via the nonsurfactant-templated sol-gel process, Journal of Materials Chemistry 2000, 10, 2490-2494.
(35) M. R. Minke, D. A. Loy and K. J. Shea, Surface area and porosity engineering of alkylene-bridged methoxysilanes; American Chemical Society, Washington, D.C.: Chicago, US, 2001.
(36) B. J. Melde, B. T. Holland, C. F. Blanford and A. Stein, Mesoporous sieves with unified hybrid inorganic/organic frameworks, Chemistry of Materials 1999, 11, 3302-3308.
(37) GJD. Soler-illia, C. Sanchez, B. Lebeau, J. Patarin. Chemical strategies to design textured materials: From microporous and mesoporous oxides to nanonetworks and hierarchical structures, Chemical Reviews, 102(11): 4093-4138, 2002 November.

1-28. (canceled)

29. A conductive organic-inorganic hybrid material comprising a mineral phase in which walls define pores forming a structured mesoporous network with open porosity; said material further comprising an organic oligomer or polymer integrated in said walls and bonded covalently to the mineral phase, and optionally another phase inside the pores, composed of at least one surface active agent; at least one of the mineral phase, and the organic oligomer or polymer having conductive and/or hydrophilic functions.

30. The material of claim 29, wherein the mineral phase has conductive and/or hydrophilic functions on the surface of its pores.

31. The material of claim 29, wherein the organic oligomer or polymer has conductive and/or hydrophilic functions.

32. The material of claim 29, wherein the optional phase composed of at least one surface active agent has conductive and/or hydrophilic functions.

33. The material of claim 29, wherein said conductive functions are selected from cation exchange groups.

34. The material of claim 33, wherein said cation exchange groups are selected from the following groups: SO₃M; —PO₃M₂; —COOM and B(OM)₂, where M represents hydrogen, a monovalent metal cation, or ⁺NR¹₄, where each R¹, independently, represents a hydrogen, an alkyl radical or an aryl radical.

35. The material of claim 29, wherein said conductive functions are selected from anion exchange groups.

36. The material of claim 35, wherein said anion exchange groups are selected from the following groups: pyridyl, imidazolyl, pyrazolyl; triazolyl; the radicals of formula ⁺NR²₃X⁻, where X represents F, Cl, Br, I, NO₃, SO₄H or OR, R being an alkyl radical or an aryl radical, and where each R², independently, represents a hydrogen, an alkyl radical or an aryl radical; and the basic aromatic or nonaromatic radicals containing at least one radical selected from imidazole, vinylimidazole, pyrazole, oxazole, carbazole, indole, isoindole, dihydrooxazole, isoxazole, thiazole, benzothiazole, isothiazole, benzimidazole, indazole, 4,5-dihydropyrazole, 1,2,3-oxadiazole, furazan, 1,2,3-thiadiazole, 1,2,4-thiadiazole, 1,2,3-benzotriazole, 1,2,4-triazole, tetrazole, pyrrole, aniline, pyrrolidine, and pyrazole radicals.

37. The material of claim 29, wherein the mineral phase is composed of at least one oxide selected from metal oxides, metalloid oxides and mixed oxides thereof.

38. The material of claim 37, wherein said oxide is selected from the oxides of silicon, titanium, zirconium, hafnium, aluminum, tantalum, tin, rare earths and mixed oxides thereof.

39. The material of claim 29, wherein the mesoporous network has an organized structure with a repeating unit.

40. The material of claim 39, wherein the mesoporous network has a cubic, hexagonal, lamellar, vermicular, vesicular or bicontinuous structure.

41. The material of claim 29, wherein the size of the pores is from 1 to 100 nm.

42. The material of claim 29, wherein the organic polymer is a thermally stable polymer.

43. The material of claim 42, wherein the organic polymer is selected from polyetherketones; polysulfones; polyethersulfones; polyphenylethersulfones;
styrene/ethylene, styrene/butadiene, and styrene/isoprene copolymers; polyphenylenes; polyimidazoles; polyimides; polyamideimides; polyanilines; polypyrroles; polysulfonamides; polypyrazoles; polyoxazoles; polyethers; poly((meth)acrylic acid)s; polyacrylamides; polyvinyls; acetal resins; polyvinylpyridines; polyvinylpyrrolidones; polyolefins; poly(styrene oxide)s; fluoro resins and polyperfluorocarbons; poly(vinylidene fluoride)s; polychlorotrifluoroethylenes; polyhexafluoropropenes; perfluoroalkoxides; polyphosphazenes; silicone elastomers; and block copolymers comprising at least one block composed of a polymer selected from the above polymers.

44. The material of claim 29, wherein the surface active agent is selected from alkyltrimethylammonium salts, alkyl phosphate salts, alkylsulfonate salts, dibenzoyltartaric acid, maleic acid, long chain fatty acids, urea, long chain amines, phospholipids, doubly hydrophilic copolymers whose amphiphilicity is generated in situ by interaction with a substrate, and amphiphilic multiblock copolymers comprising at least one hydrophobic block in combination with at least one hydrophilic block.

45. A membrane comprising the material of claim 29, optionally deposited on a support.

46. An electrode comprising the material of claim 29.

47. A fuel cell comprising at least one membrane comprising a conductive organic-inorganic hybrid material comprising a mineral phase in which walls define pores forming a structured mesoporous network with open porosity; said material further comprising an organic oligomer or polymer integrated in said walls and bonded covalently to the mineral phase, and optionally another phase inside the pores, composed of at least one surface active agent; at least one of the mineral phase, and the organic oligomer or polymer having conductive and/or hydrophilic functions, said membrane optionally deposited on a support;
and/or at least one electrode comprising a conductive organic-inorganic hybrid material comprising a mineral phase in which walls define pores forming a structured mesoporous network with open porosity; said material further comprising an organic oligomer or polymer integrated in said walls and bonded covalently to the mineral phase, and optionally another phase inside the pores, composed of at least one surface active agent; at least one of the mineral phase, and the organic oligomer or polymer having conductive and/or hydrophilic functions.

48. A process for preparing the material of claim 29, comprising the following steps:
a)—synthesizing a precursor compound A, composed of an organic oligomer or polymer which carries precursor functions of the mesoporous mineral phase, and preparing an organic-inorganic hybrid solution in a solvent of said precursor compound A;
b)—hydrolyzing the organic-inorganic hybrid solution obtained in step a) and allowing the solution to age;
c)—diluting the hydrolyzed and aged organic-inorganic hybrid solution of the precursor compound A, obtained in step b), in a solvent of a mineral precursor B intended to constitute the mesoporous mineral phase, whereby a new organic-inorganic hybrid solution is obtained;
d)—hydrolyzing the organic-inorganic hybrid solution obtained in step c) and allowing the solution to age;
e)—preparing a solution, in a solvent, of a surface active agent D, a templating, texturizing, agent for the mesoporous mineral phase;
f)—mixing the solution obtained in step c) with the solution obtained in step e) to give a solution S;
g)—optionally, hydrolyzing the solution S obtained in step f) and allowing the solution S to age;
h)—depositing or impregnating the hydrolyzed and aged hybrid solution S on a support;
i)—evaporating solvents under controlled pressure, temperature, and humidity conditions;
j)—carrying out a heat treatment to consolidate the material;
k)—optionally removing the surface active agent D completely or partially;
l)—optionally separating or removing the support.

49. The process of claim 48, wherein additionally a chelating agent E is added to the solution S obtained in step f).

50. The process of claim 48, wherein, during step c), to the solution based on the organomineral precursor A, a compound C is further added which carries, on the one hand, conductive and/or hydrophilic functions and/or precursor functions of conductive and/or hydrophilic functions, and, on the other hand, functions capable of undergoing bonding to the surface of the pores of the mesoporous network.

51. The process of claim 48, wherein the process further comprises a final step of treatment to liberate or generate conductive and/or hydrophilic functions on the surface of the pores of the material.

52. The process of claim 48, wherein the organic-inorganic hybrid solution obtained in step a) is left to age at a temperature of 0 to 300° C.; at a pressure of 100 Pa to 5·10⁶ Pa; for a time of a few minutes to a few days.

53. The process of claim 48, wherein the organic-inorganic hybrid solution obtained in step c) is left to age at a temperature of 0° C. to 300° C.; at a pressure of 100 Pa to 5·10⁶ Pa; for a time of a few minutes to several days.

54. The process of claim 48, wherein the solution S obtained in step f) is left to age at a temperature of 0° C. to 300° C.; at a pressure of 100 Pa to 5·10⁶ Pa; for a time of a few minutes to a few days.

55. The process of claim 48, wherein the solvents are evaporated at a temperature of 0 to 300° C.; at a relative humidity (RH) of 0 to 100%.

56. The process of claim 48, wherein, in step h), the organic-inorganic hybrid solution is deposited or impregnated on a support by a method selected from the method of deposition by centrifugal coating known as spin coating, the method of deposition by immersion and withdrawal known as dip coating, the method of deposition by laminar coating known as meniscus coating, the method of deposition by spraying known as “spray coating”, the method of deposition by casting and the method of deposition by evaporation.

57. The material of claim 37, wherein said oxide is selected from the oxides of europium, cerium, lanthanum, and gadolinium, and mixed oxides thereof.

58. The material of claim 29, wherein the size of the pores is from 1 to 50 nm.

59. The process of claim 48, wherein the organic-inorganic hybrid solution obtained in step a) is left to age at a temperature of 20° C. to 200° C.; at a pressure of 1000 Pa to 2·10⁵ Pa; for a time of one hour to one week.

60. The process of claim 48, wherein the organic-inorganic hybrid solution obtained in step c) is left to age at a temperature of 20° C. to 200° C.; at a pressure of 1000 Pa to 2·10⁵ Pa; for a time of one hour to one week.

61. The process of claim 48, wherein the solution S obtained in step f) is left to age at a temperature of 20° C. to 200° C.; at a pressure of 1000 Pa to 2·10⁵ Pa; for a time of one hour to one week.

62. The process of claim 48, wherein the solvents are evaporated at a temperature of 10° C. to 160° C.; at a relative humidity (RH) of 20% to 95%.
